(19) United States
(12) Patent Application Publication
(10) Pub. No.: US 2016/0183481 A1
(43) Pub. Date: Jun. 30, 2016

(54) CENTER-CUT STUMP GRINDER WITH WIDE LATERAL REACH

(71) Applicant: GREG BARRETO, LA GRANDE, OR (US)

(72) Inventor: GREG BARRETO, LA GRANDE, OR (US)

(21) Appl. No.: 14/932,269

(22) Filed: Nov. 4, 2015

Related U.S. Application Data
(60) Provisional application No. 62/075,234, filed on Nov. 4, 2014.

(51) Int. Cl. A01G 23/06

(52) U.S. Cl. CPC A01G 23/067

(57) ABSTRACT

A powered stump grinder at the center front of a walk-behind machine is disclosed. The grinder machine has a front cutter head assembly pivotally connected to the walk-behind machine by a central pivot assembly. The central pivot assembly is securely, pivotally connected to the center front part of the frame or body of the machine, for example, by temporary securement to the frame or body via a conveniently removable mounting plate system. The central pivot assembly includes a vertical pivot axle/axis, for lateral movement of the connected front cutter head assembly. Generally horizontal hydraulic cylinders, extending between the mounting plate and left and right lateral portions of the pivot assembly, serve to control lateral movement of the connected front cutter head assembly by pivoting the pivot assembly, which in turn pivots the connected cutter arm, and hence, the cutter head assembly. A more vertical hydraulic cylinder on the central pivot assembly has a ram which is connected to and controls vertical movement of the cutter arm, and hence the front cutter head assembly.

This application claims priority of U.S. Provisional Application Ser. No. 62/075,234, filed November 4, 2014, the entire disclosure of which is incorporated herein by this reference.

### BACKGROUND OF THE DISCLOSED TECHNOLOGY

1. Field of the Disclosed Technology

This invention relates generally to powered tools for removing tree stumps by chipping, grinding or sawing. More specifically, this invention relates in one embodiment to a pivot head assembly of a stump grinder machine for supporting and controlling a cutter head assembly so that the cutter head can reach out from the front of the machine, and move up and down, and also from side to side, to operate effectively on the stump to be removed. Preferably, the pivot head assembly is mounted and secured to the stump grinder machine for enabling lateral rotation/swinging of the cutter head assembly about a generally vertical axis preferably located near the center of the front of the grinder machine.

2. Related Art

For stump grinders, the industry has one general version which has a grinder head on one lateral side for easier viewing by the operator. The industry has another general version which has a grinder head located centrally which is pivoted back and forth, in effect, to sweep away the tree stump to be removed.

U.S. Pat. No. 3,198,224 (Hiley) is one example of the grinder head being located centrally, and rotated horizontally back-and-forth, in this case, at the rear end of a tractor. Two horizontal hydraulic cylinders and pistons pushing/pulling directly on a pivot head obtain about 80° of rotation of a connected, extending boom.

U.S. Pat. No. 3,336,958 (Carlton) is one example of a grinder head being on one lateral side, with one wheel of a grinding machine being turned while the other wheel is fixed to rotate the grinder head horizontally.

U.S. Pat. No. 5,718,271 (Engelhoven) is one example of a grinder head being moved by a backhoe arm of a construction tractor which has a central boom which supports and controls a grinder head.

U.S. Pat. No. 5,829,497 (Maroney) is one example of a grinder head being moved by first and second hydraulic cylinder and piston units in a frame supported by the three point hitch of an agricultural tractor.

U.S. Pat. No. 6,435,234 (Paumier) is one example of a grinder head being swept horizontally as a result of the rotation of a central cab containing a boom which supports and controls a grinder head.

U.S. Pat. No. 7,150,300 (Peterson) is one example of a tilting grinder head being swept horizontally as a result of the rotation of a central boom which holds and controls a grinder head.

US Published Patent Application #2009/0101234 (Hart) is one example of a grinder head being held and supported by a central boom which also holds and supports a central power unit, in this case an internal combustion engine.

US Published Patent Application #2012/0175018 (Knipp et al.) is another example of a grinder head being on one lateral side of a grinder machine.

### SUMMARY OF THE DISCLOSED TECHNOLOGY

This invention is an improved stump grinder machine with a central pivot head assembly mounted and secured near the center of the front of the grinder machine for supporting and controlling the cutter head assembly. In this respect, the present machine is referred to as a “center-cut” stump grinder. In contrast, different versions of a “side-cut” grinder machine are disclosed in U.S. Pat. No. 3,336,958 (Carlton), and U.S. Published Patent Application #2012/0175018 (Knipp et al.), discussed above. In the “side-cut” machine, a pivot head assembly is mounted offset, more to one side than the other side of the front of a grinder machine.

According to a preferred embodiment of the present invention, the back part of the central pivot head assembly is mounted at or near a center front part of the grinder machine's frame or body, preferably via a mounting plate. The mounting plate secures and supports the back part of the pivot head assembly, which pivot head assembly rotates about a generally vertical axis. The mounting plate also supports on its top a pair of generally horizontal, lateral hydraulic cylinders, one for connection with the piston or ram thereof to each lateral side of the pivot head assembly, which lateral cylinders and rams act to turn the pivot head assembly from side-to-side by extending on one side and retracting substantially simultaneously on the other side. This way, the front cutting head assembly, which is attached to the pivot head assembly, may be effectively rotated horizontally/swung laterally in a wide arc to engage at least the complete width of even a large stump to be ground, or even engage several stumps sequentially without having to move the whole grinder machine to another location, and/or to effectively reach a stump with the cutting head assembly even when adjacent structure (such as surrounding buildings, fences, rocks, trees or landscaping, for example) limits the locations in which the main body of the machine can be placed.

The front part of the central pivot head assembly supports a more vertical central hydraulic cylinder which extends forwardly therefrom, and the piston or ram of which connects to a generally central part of the cutting head assembly. The front part of the pivot head assembly also supports the back part of the cutting head assembly on a generally horizontal, transverse axis. This way, as the ram of the central hydraulic cylinder extends forwardly and down, the cutting head assembly extends outwardly and rotates vertically down to engage the stump to be ground. Likewise, as the more vertical central cylinder retracts rearwardly and up, the cutting head assembly retracts inwardly and rotates vertically upwardly to disengage from the stump, and for transport.

### BRIEF DESCRIPTION OF THE DRAWINGS

FIG. 1 is a schematic, partial, right side view of one embodiment of the subject stump grinder machine, with the cutting head assembly extended centrally and downwardly.

FIG. 2 is the view of FIG. 1, but with the cutting head assembly extended upwardly.

FIG. 3 is a top, right side, schematic perspective view of the embodiment depicted in FIG. 1, but with the cutting head assembly rotated horizontally or pivoted laterally to the right of the center of the grinder machine.

FIG. 4 is the view of FIG. 3, but with the cutter head assembly rotated horizontally or pivoted laterally to the left of the center of the grinder machine.

FIG. 5 is a schematic, complete, top view of the embodiment depicted in FIG. 3.

FIG. 6 is a schematic, complete, top view of the embodiment depicted in FIG. 4. From FIGS. 5 and 6 it may be seen that the cutter head assembly for the subject stump grinder machine may pivot to rotate laterally left and right in a total arc of about 135°.

FIG. 7 is a schematic, left side, top perspective view of one embodiment of the subject stump grinder machine. In FIG. 7, the list of numbered parts refers to the circled, numbered items in FIG. 8, below. In FIG. 7, the “Options; BS/K” notation refers to the optional Briggs & Stratton Co. and Kohler Co. engines available.

FIG. 8 is a schematic, partially exploded view of the embodiment depicted in FIG. 7, with certain parts numbered according to the table beside FIG. 7.

FIG. 9 is a detail view of the cutter head assembly depicted in FIG. 8. In FIG. 9, the list of numbered parts refers to the circled, numbered items in FIG. 10, below.

FIG. 10 is a schematic, exploded view of the cutter head assembly depicted in FIG. 9, with certain parts numbered according to the table above FIG. 9.

FIG. 11 is a schematic, exploded, top, left perspective detail view of the mounting plate and pivot head assembly depicted in FIG. 8, with certain parts numbered according to the table beside FIG. 11.

FIG. 12 is a view like FIG. 7, but of a slightly different embodiment with a slightly different control assembly (part #24), and an additional chip shield (part #31). In FIG. 12, the list of numbered parts refers to the circled, numbered items in FIG. 13, below.

FIG. 13 is a view like FIG. 8, but of the different embodiment depicted in FIG. 12. The outlined part of FIG. 13 is partially depicted in FIG. 14, below (except the chip shield, (part #31) which is not shown in FIG. 14).

FIG. 14 is a schematic, enlarged detail view of the outlined part of FIG. 13 (except the chip shield (part #31)). Also, in FIG. 14 the circled, numbered items of FIG. 13 have been removed, and the call-out numbers from the DETAILED DESCRIPTION, below, have been added.

### DETAILED DESCRIPTION OF CERTAIN EMBODIMENTS OF THE DISCLOSED TECHNOLOGY

In a preferred embodiment, a powered, walk-behind stump grinder machine is disclosed. The grinder machine has a front cutter head assembly pivotally connected to a central pivot assembly adapted for horizontal/generally-horizontal, or “lateral”, pivoting, so that the attached front cutter head assembly also pivots horizontally, relative to the main body of the machine, the pivot assembly and the ground, on a generally vertical axis. The pivot assembly is, in turn, at a back part thereof securely and pivotally connected to the center front part of an optional mounting plate that is securely connected to the front of the frame or body of the machine. The pivot assembly may be temporarily secured to the frame or body of the machine via a removable mounting plate. Two generally horizontal hydraulic cylinders on the mounting plate have rams connected to the pivot assembly, one on each lateral side of the generally vertical axis for the pivot assembly, which control the lateral movement of the pivot assembly and the attached front cutter head assembly. In addition, the central pivot assembly preferably is also adapted for vertical/generally-vertical, or “up and down”, pivoting of the cutter head assembly, relative to the main body of the machine, the pivot assembly and the ground, on a generally horizontal axis. A more vertical hydraulic cylinder mounted on the pivot assembly has a ram which connects to and controls said vertical/generally-vertical movement of the front cutter head assembly.

Referring to the Figures, there are depicted several preferred, but not all, embodiments of the subject stump grinder machine.

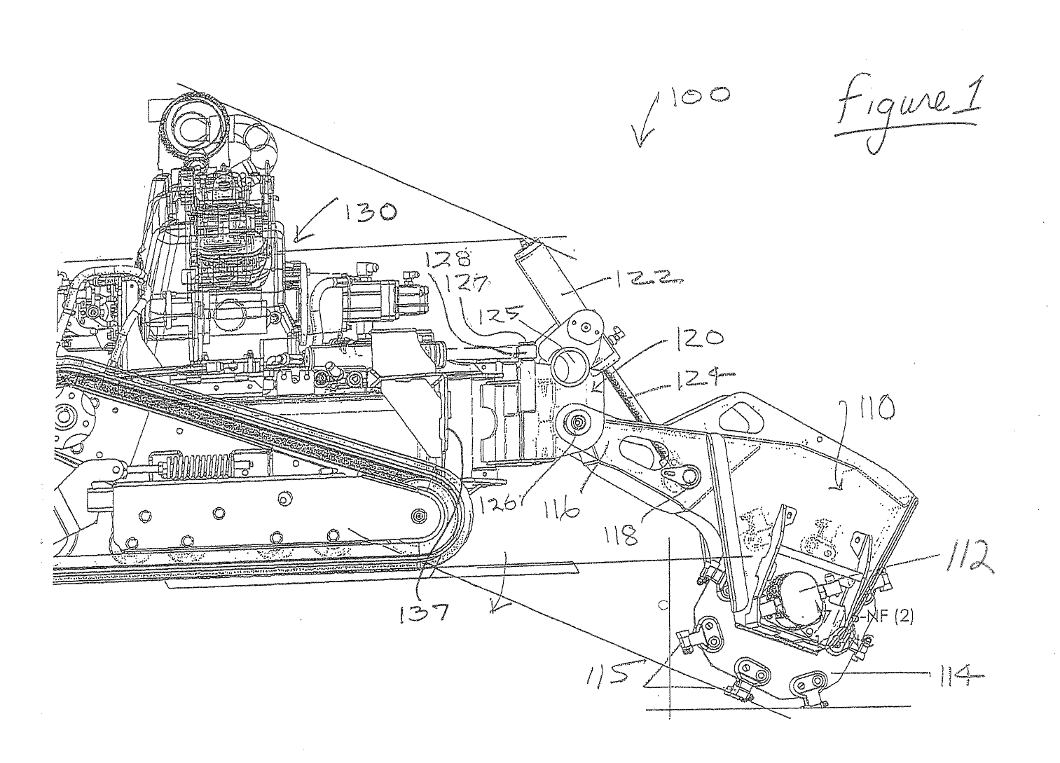

FIG. 1 depicts a schematic, partial right-side view of one embodiment of the subject stump grinder machine. Stump grinder 100 has front cutter head assembly 110, middle or central pivot head assembly 120, and back, powered, walk-behind assembly 130 that is one example of a “main body” of the machine. Front cutter head assembly 110 has powerful hydraulic motor 112 on its front part which rotates cutting wheel 114 at high speed so that cutting teeth 115 thereon may contact and grind the stump. These parts, motor 112, wheel 114 and teeth 115 of the front part of cutter head assembly 110, may be of conventional design and manufacture, including, for example, a powerful electrical motor (not shown).

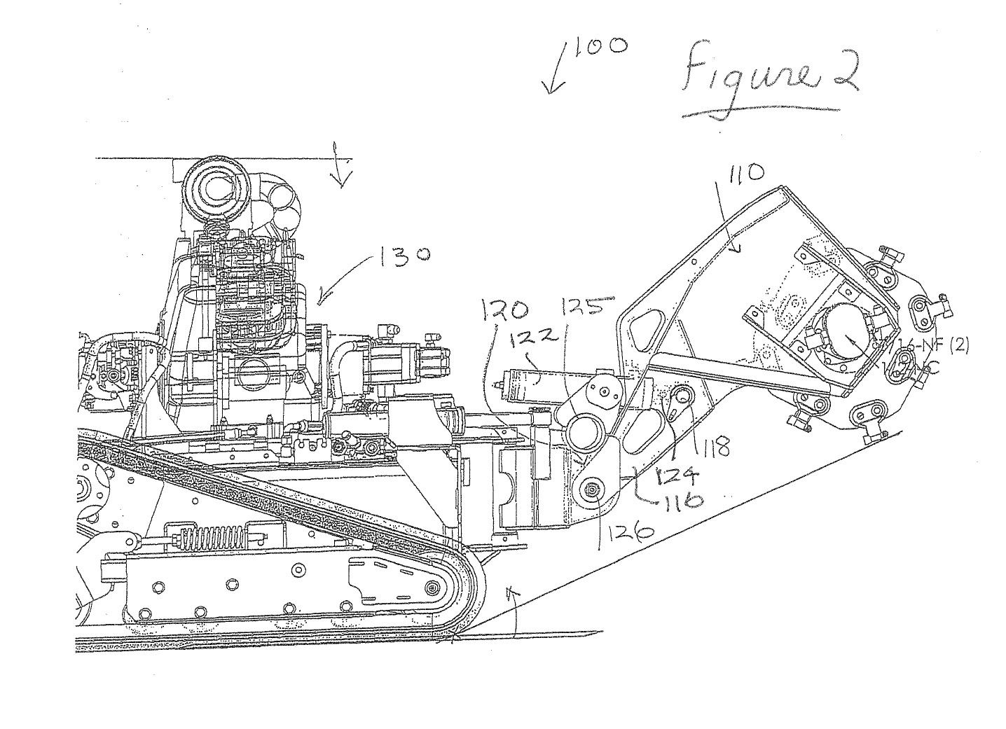

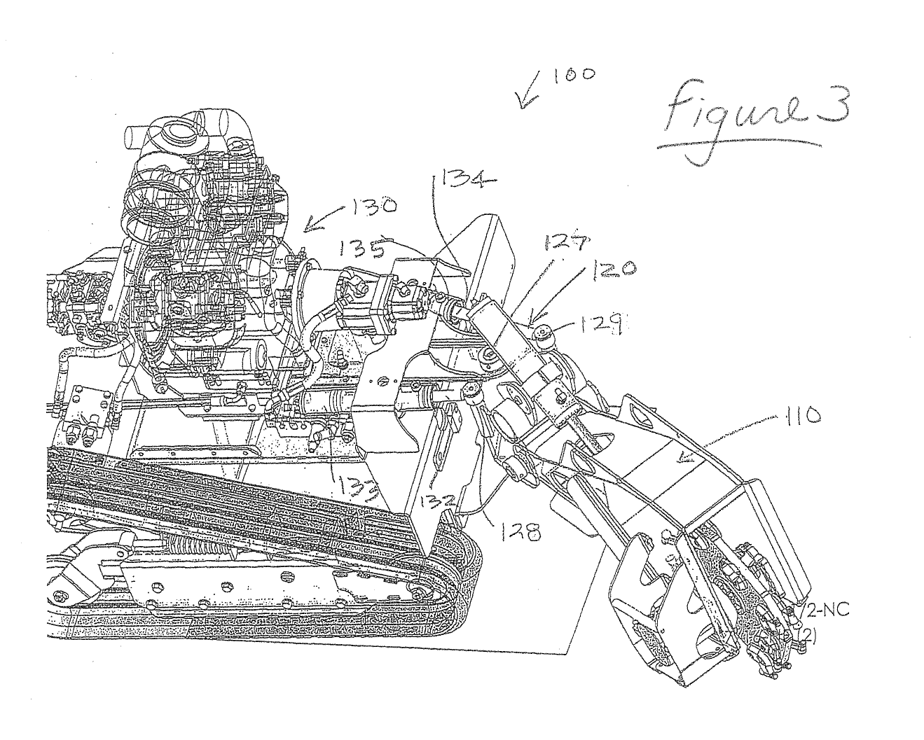

The back part of cutter head assembly 110 has cutter arm 116 for pivotally connecting to the central pivot head assembly 120 at cutter arm horizontal pivot axle/axis 126. On cutter arm 116 forward of axle/axis 126 (but rearward of the cutter head assembly 110), is front generally horizontal hydraulic pivot axle/axis 118, for pivotal connection to the “more vertical” central hydraulic cylinder 122 with central hydraulic ram 124 on central pivot head assembly 120. By “more vertical” is meant that hydraulic cylinder 122 and its ram 124 lie and move in a generally more vertical plane, for example, between the positions shown in FIG. 1 (for a fully-lowered cutter head assembly 110) and in FIG. 2 (for a fully-raised cutter head assembly 110), compared to the consistently generally horizontal hydraulic cylinders 133 and 135 depicted in, for example, FIG. 3, below.

Central pivot head assembly 120 has back generally horizontal hydraulic pivot axle/axis 125 so that central hydraulic cylinder 122 may rotate rearwardly when the cutter head assembly 110 is rotated to lift it upwardly (as in FIG. 2). This happens when central ram 124 is retracted within central hydraulic cylinder 122. This way, central hydraulic cylinder 122 and central ram 124 control the elevation of the cutter head assembly 110 by lifting and lowering it about cutter arm horizontal pivot 126 which connects cutter arm 116 to central pivot head assembly 120.

In turn, central pivot head assembly 120 is pivotally connected to back, powered, walk-behind assembly 130 via mounting plate 137 by central pivot head vertical pivot axle/axis 127, which is mostly hidden from view in FIG. 1 by right side hydraulic pivot 128.

FIG. 2 depicts the view of FIG. 1, but with the cutting head assembly 110 lifted to extend outwardly and upwardly. By comparing FIGS. 1 and 2, it may be seen that the lift from the upward rotation of cutting head assembly 110 about the horizontal axes of pivots 118 (connection of ram 124 to the cutter arm 116), 125 (connection of the cylinder 122 to the pivot head assembly 120), and 126 (connection of the cutter arm 116 to the pivot head assembly 120) is caused by the retraction of ram 124 into more vertical central hydraulic cylinder 122.

FIG. 3 depicts a top, right side perspective view of the embodiment of FIG. 1, but with the cutting head assembly 110 rotated to extend laterally to the right of stump grinder 100. In this FIG. 3, central pivot head vertical pivot axle/axis 127, discussed above, is more clearly visible. Also, in this FIG. 3, it is more clearly evident that, besides right side hydraulic pivot 128, there is also left side hydraulic pivot 129. Hydraulic pivots 128 and 129 are both separated from central pivot head vertical pivot axle/axis 127 by a similar or same horizontal distance. By “similar or same horizontal distance” is meant, in the context of conventional manufacturing techniques and tolerances, that pivot 128 and 129 are generally geometrically symmetrical about central pivot head vertical pivot axle/axis 127.

Hydraulic pivots 128 and 129 are connected by right side hydraulic ram 132 and left side hydraulic ram 134, respectively, which rams are connected to right side hydraulic cylinder 133, and to left side hydraulic cylinder 135, respectively. This way, cutter head assembly 110 may be rotated to swing laterally to the right by right side hydraulic ram 132 retracting, while at the same time left side hydraulic ram 134 extending. Likewise, cutter head assembly 110 may be rotated to swing laterally to the left by right side ram 132 extending, while left side ram 134 simultaneously retracting. This way, right side hydraulic cylinder 133 and its ram 132, and left side hydraulic cylinder 135 and its ram 134 control the lateral location of the cutter head assembly by swinging it left and right about the vertical axles/axes of vertical pivot 127, and hydraulic pivots 128 and 129.

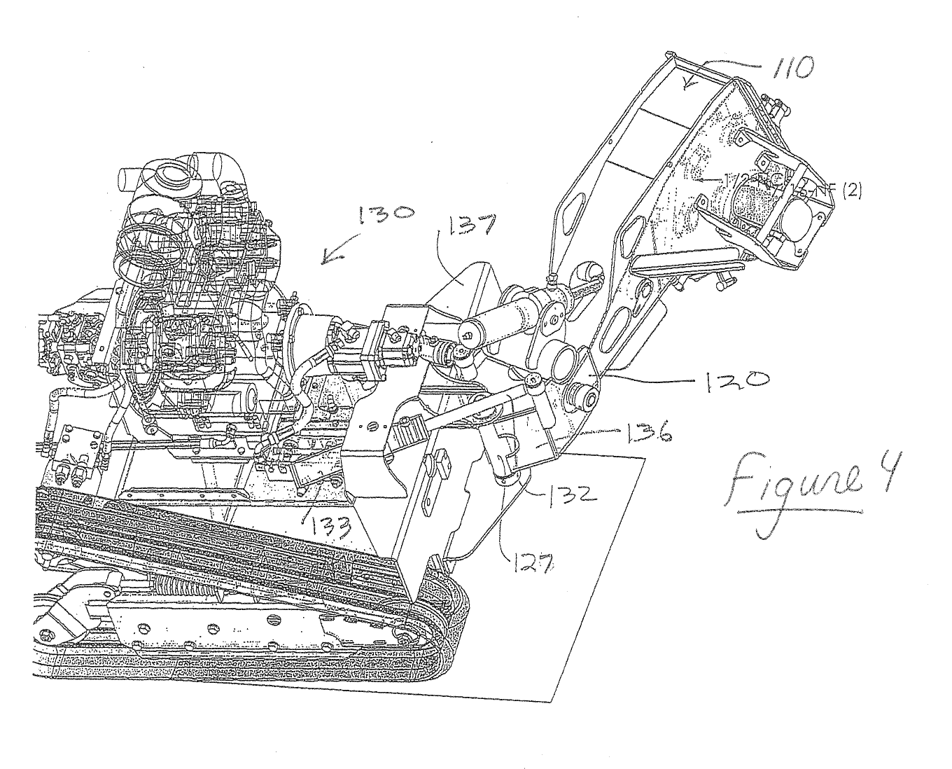

FIG. 4 depicts the view of FIG. 3, but with the cutter head assembly 110 extended laterally to the left of stump grinder 100. In this FIG. 4, the bottom part of central pivot head vertical pivot axle/axis 127 is more visible, as is right side hydraulic ram 132 and right side hydraulic cylinder 133. Also, the structural connector 136 between the front part of central pivot head assembly 120 and central pivot head vertical pivot 127 is well visible.

FIG. 4 also depicts mounting plate 137 which optionally connects and secures the back part of middle pivot head assembly 120 to the front part of the frame or body of back, powered, walk-behind assembly 130. Mounting plate 137 may be of a permanent or temporary, that is, conveniently removable, nature. When permanently installed, mounting plate may be integrally formed with, or welded to, for example, the front part of the frame or body of walk-behind assembly 130. When temporarily installed, mounting plate 137 may be effectively secured to walk-behind assembly 130 by nuts and bolts or other removable fasteners in conventional manner, and therefore be conveniently removable.

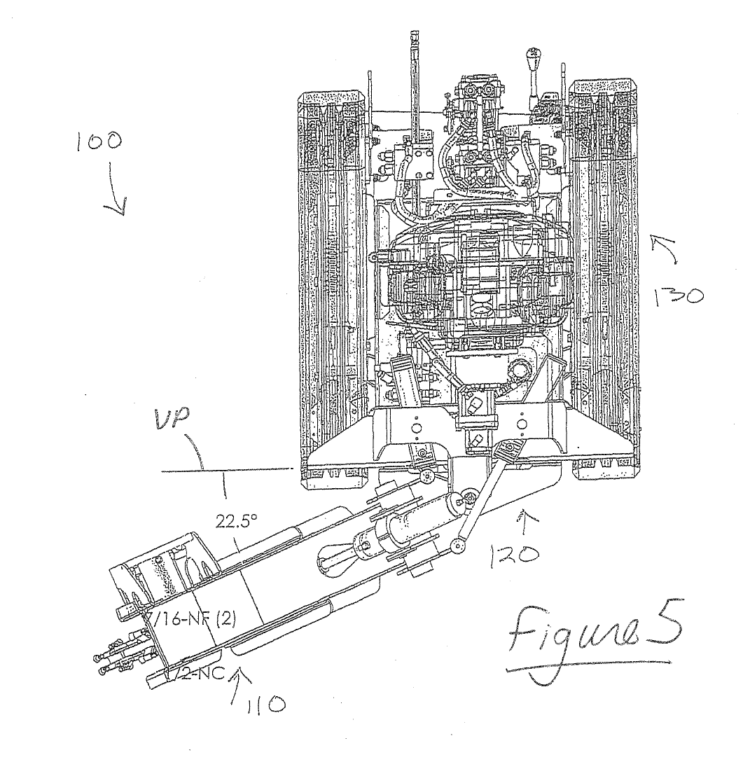

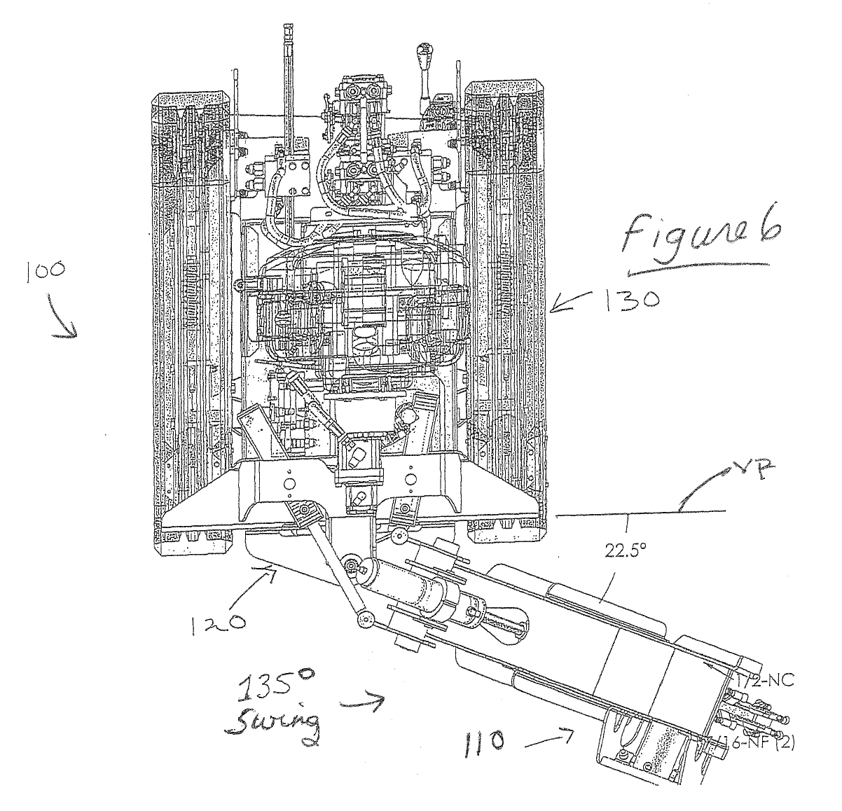

FIGS. 5 and 6 are top views of the subject grinder machine 100, with the cutting head assembly 110 extending laterally to the right of the machine in FIG. 5, and laterally to the left of the machine in FIG. 6. From these Figures it is clear that the cutting head assembly 110 may be swung in an arc between locations at the far right and at the far left of the walk-behind assembly 130. For example, as shown in FIGS. 5 and 6, these locations may correspond to the right side of the cutting head assembly 110 swinging right all the way to about 22.5 degrees from the vertical plane VP of the front of the assembly 130, and the left side of the cutting head assembly 110 swinging left all the way to about 22.5 degrees from the vertical plane VP of the front of the assembly 130. As thus described, it may be said that the cutting head assembly 110 may be swung in an arc of about 135° from the center of the front of the grinder machine 100.

Another way of measuring and describing the lateral movement is to measure the rotation/swing at the centerline of the cutting head assembly 110, and the cutter arm 116, relative to the vertical plane VP of the front of the assembly 130. Thus-measured, it may be also be said that the cutting head assembly 110 may be swung in an arc of about 135° from the center of the front of the grinder machine 100.

The wide lateral rotation/swing of the cutting head assembly 110 preferably is greater than 120 degrees, more preferably in the range of about 120-150 degrees, and most preferably about 130-140 degrees. Depending on the dimensions of the grinder machine, this may correspond to lateral travel of the cutting head in an arc of about 4-8 feet, for example. This corresponds to a far greater rotation/swing than would be necessary to match the diameter of an “average” stump, for example, far greater than ≦60 degrees of rotation/swing and an arc of about ≦2 feet for a 1.5-2 foot diameter stump.

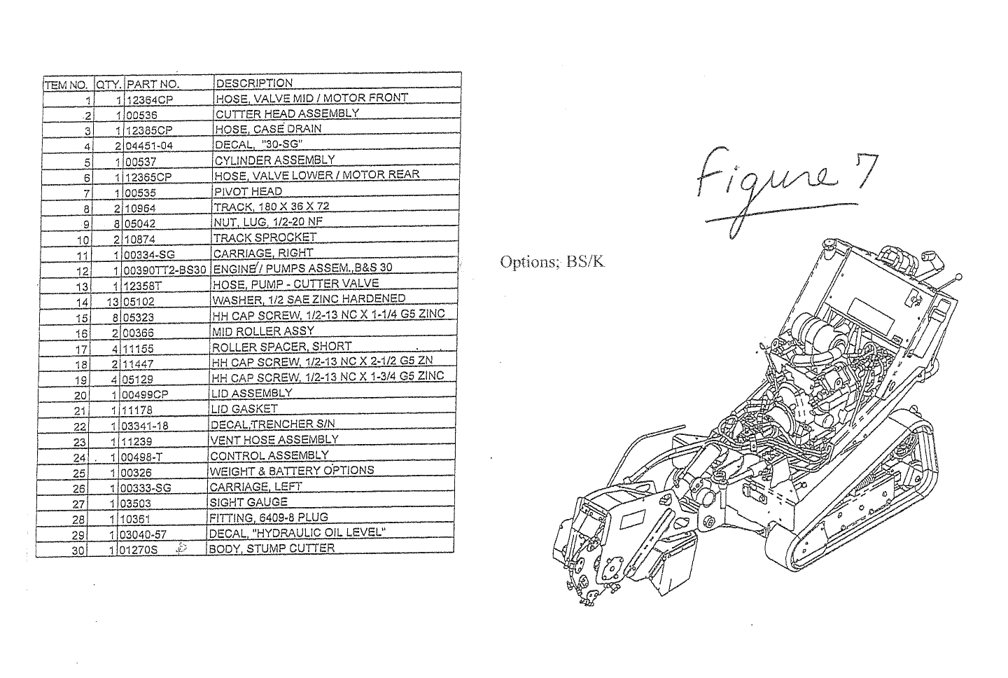

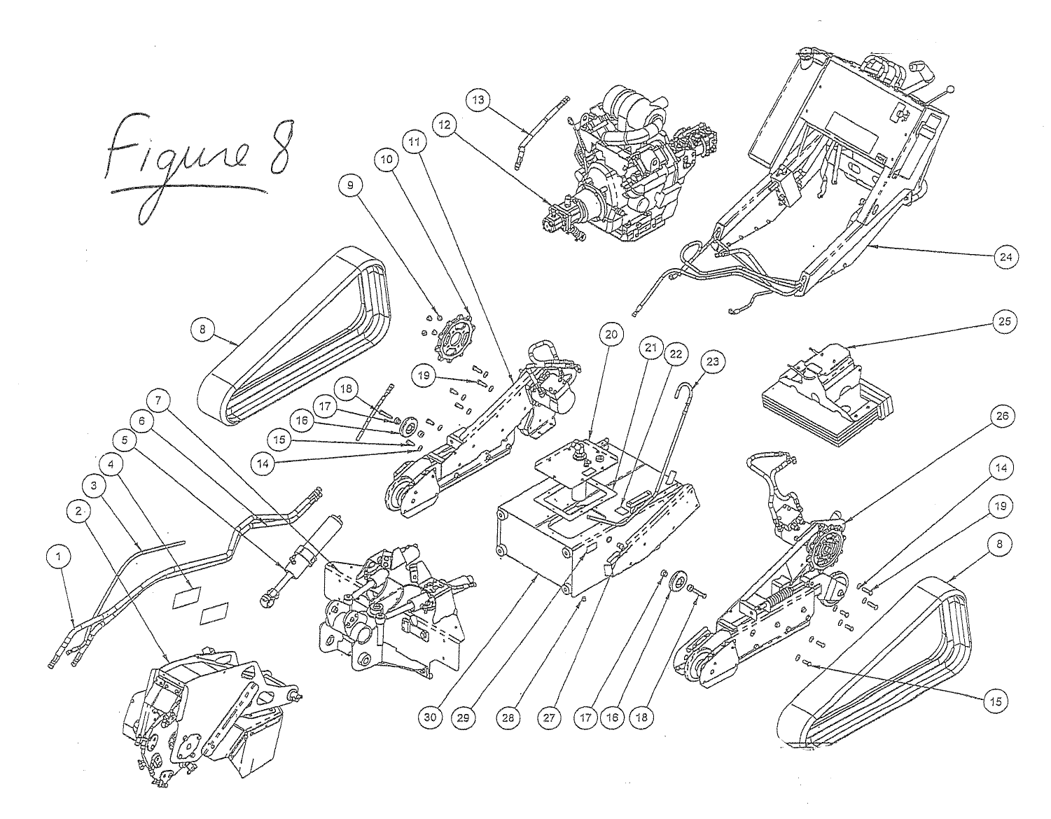

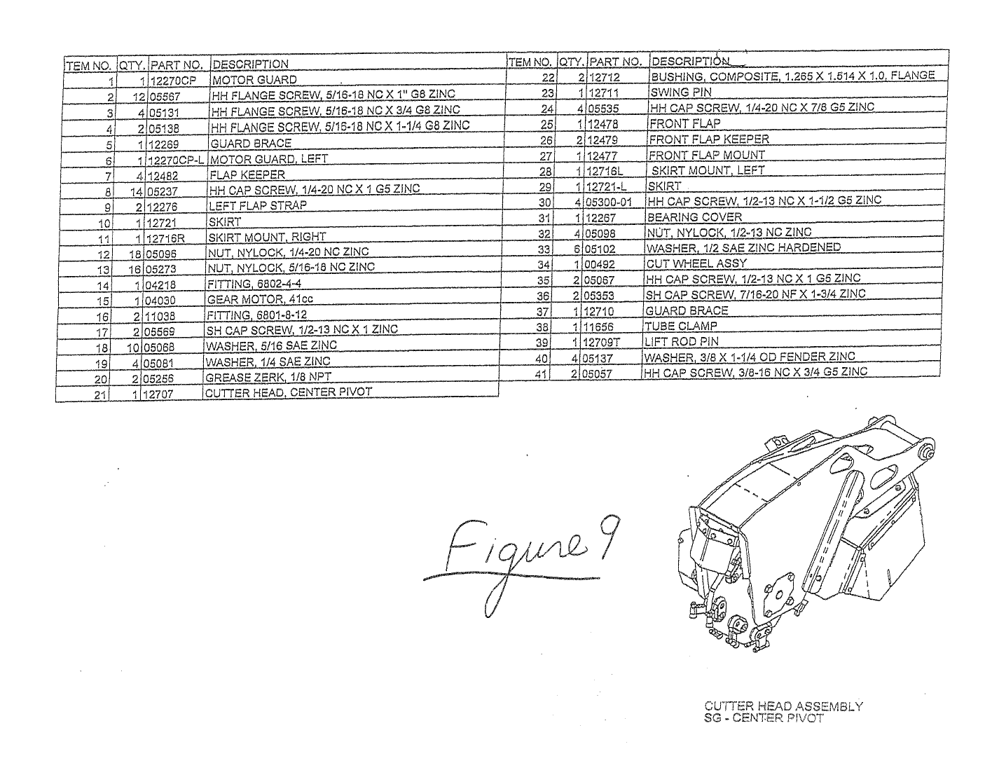

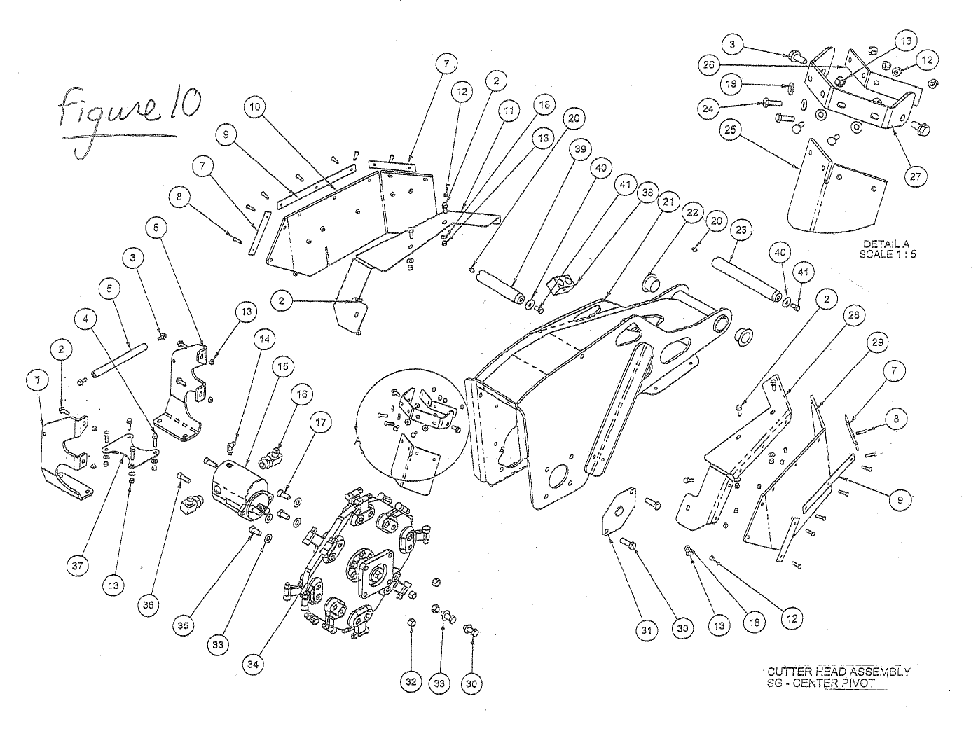

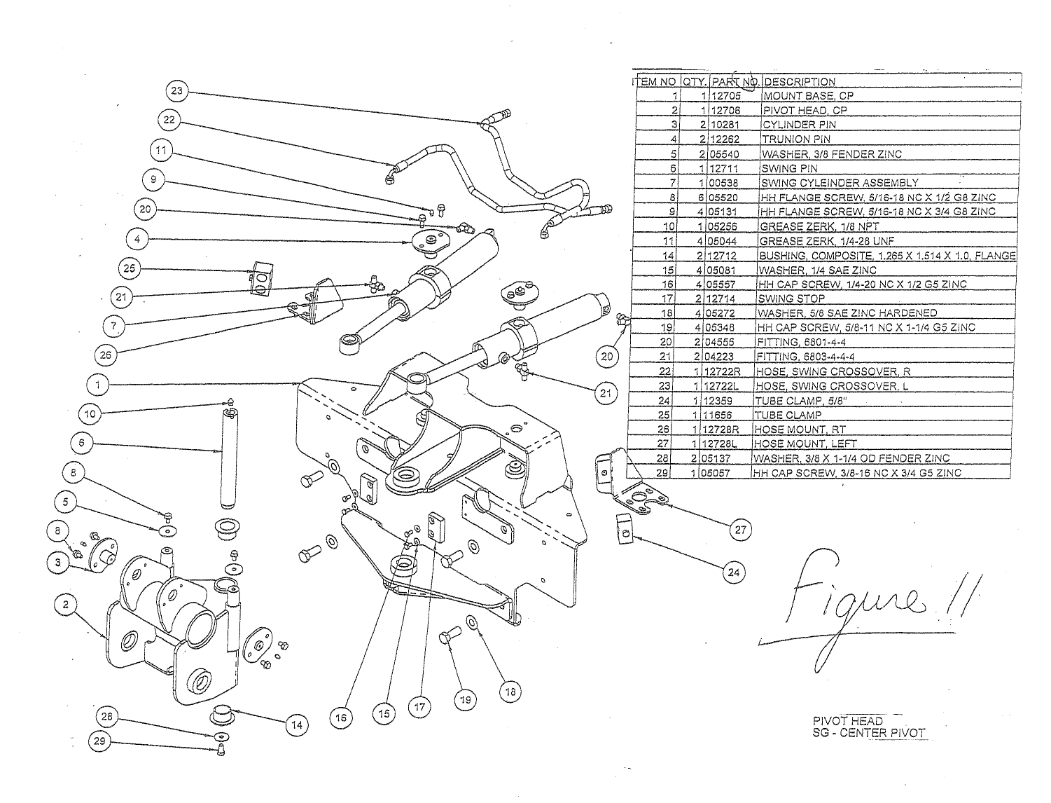

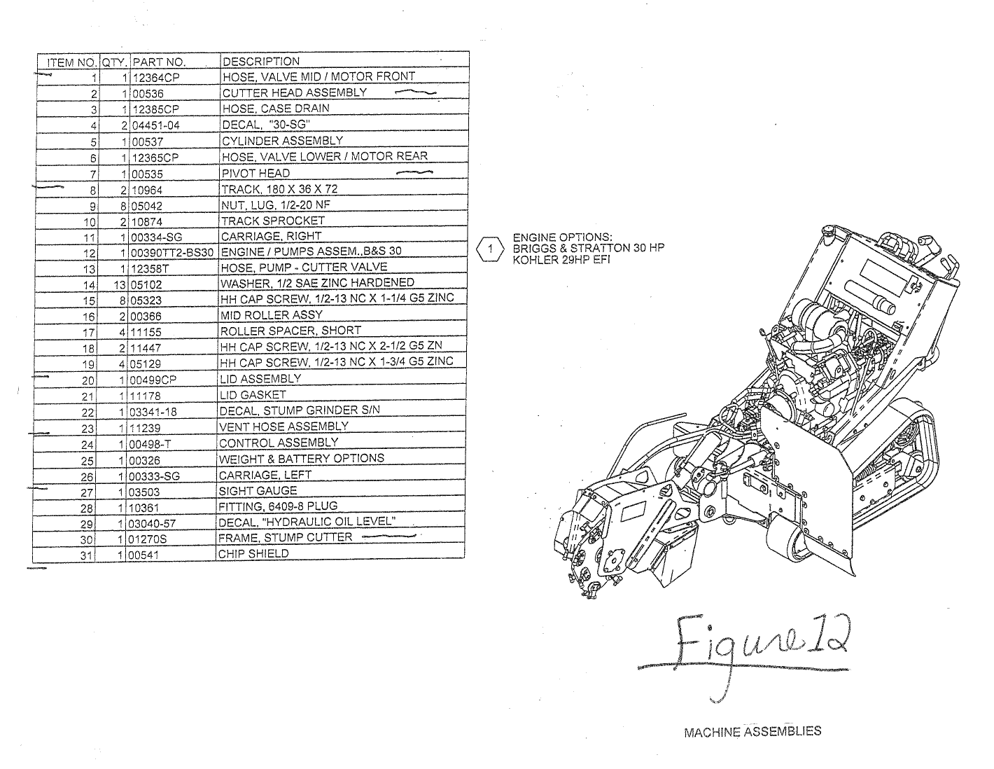

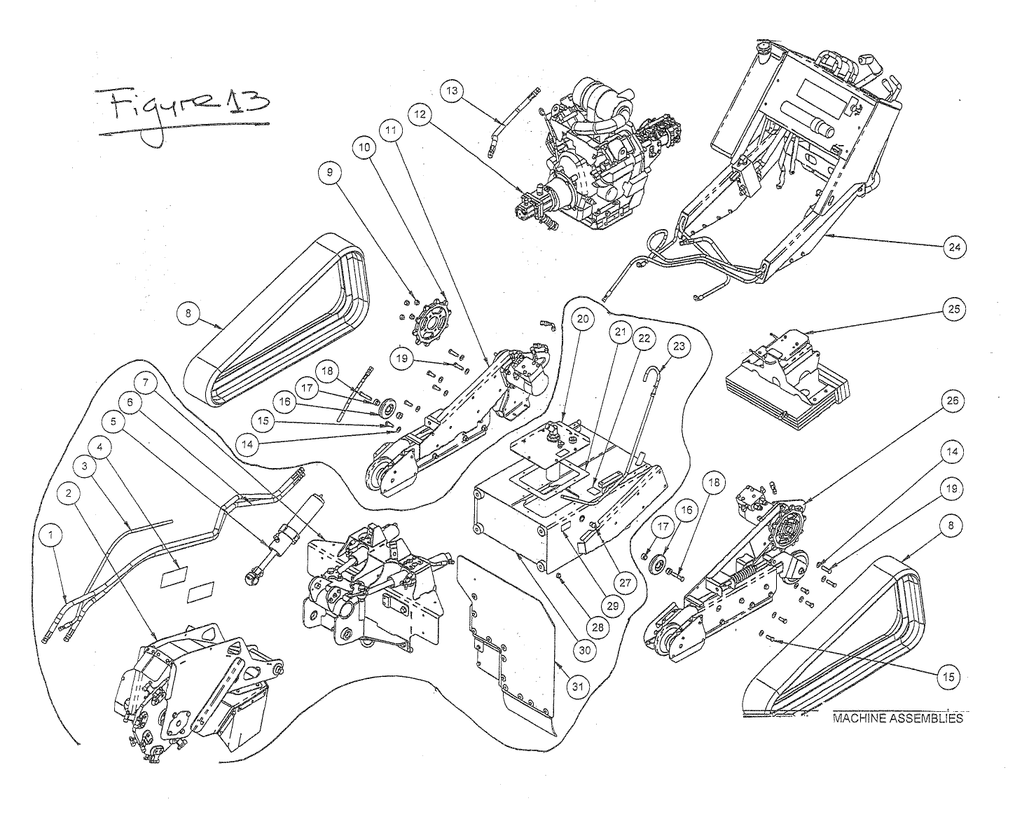

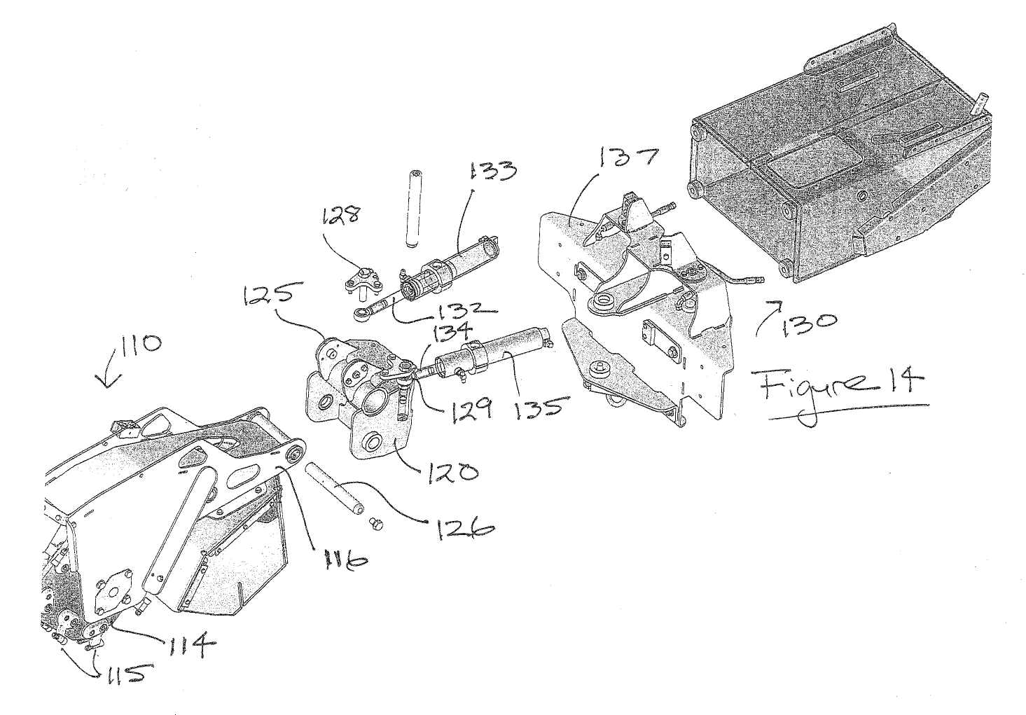

FIGS. 7-14 depict additional views of this first embodiment, discussed in detail above, and a second embodiment, of the stump grinder machine. These Figures include exploded and detailed views, as well as relevant parts lists so the design and assembly of the subject machine may be completely understood.

Although this disclosed technology has been described above with reference to particular means, materials and embodiments, it is to be understood that the disclosed technology is not limited to these disclosed particulars, but extends instead to all equivalents within the broad scope of this disclosure, including text, tables, drawings and claims.

I claim:

1. A stump grinder machine comprising a front cutter head assembly vertically pivotally connected to a front part of a central pivot head assembly which central pivot head assembly is also horizontally pivotally connected on a back part thereof to a front, central part of a frame or body of said stump grinder machine, the vertically pivotal connection of said front cutter head assembly being made by a central hydraulic cylinder connected to a front part of said central pivot head, the ram of which central hydraulic cylinder is connected to a central part of said cutting head assembly, and the horizontally pivotal connection of said central pivot head being made by two generally horizontal hydraulic cylinders, both connected to a front part of the frame or body of said stump grinder machine, the rams of which generally horizontal hydraulic cylinders being connected to said central pivot head assembly at lateral pivots, one on each lateral side of said central pivot head assembly, said lateral pivots being separated by a same or similar horizontal distance from a vertical pivot axis of said central pivot head assembly.

2. A stump grinder machine as in claim 1, wherein the central pivot head assembly is horizontally pivotally connected to a central part of a mounting plate which is connected to a front part of said frame or body of said grinder machine.

3. A stump grinder machine as in claim 2, wherein the mounting plate is conveniently removably connected to the front part of said frame or body of said grinder machine.

4. A central pivot head assembly for a stump grinder machine, the stump grinder machine comprising a front cutter head assembly vertically pivotally connected to a front part of said pivotal head assembly, which pivotal head assembly is horizontally pivotally connected at a back part thereof to a central front part of a frame or body of said stump grinder machine, the vertically pivotal connection to the front cutter head assembly being made by a central hydraulic cylinder connected to a front part of said central pivot head, the ram of said central hydraulic cylinder being adapted to connect to a central part of said cutting head assembly for vertical movement thereof, the pivot head assembly also being adapted to connect, near a back part thereof to the rams of two generally horizontal hydraulic cylinders at lateral hydraulic pivot points, one on each lateral side of said central pivot head, said lateral hydraulic pivot points being separated from on another by a same or similar horizontal distance from a vertical pivot point on said pivot head assembly for horizontal movement of said pivot head assembly.

5. A central pivot head assembly as in claim 4, wherein the central pivot head assembly is adapted to be pivotally connected to a mounting plate which is connected to a front part of same frame or body of said grinder machine.
